(19) United States
(12) Patent Application Publication
(10) Pub. No.: US 2005/0243925 A1
(43) Pub. Date: Nov. 3, 2005

(54) Video coding method and device

(75) Inventor: Vincent Bottreau, Rennes (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/527,109

(22) PCT Filed: Aug. 27, 2003
(86) PCT No.: PCT/IB03/03835

§ 371 Date: Mar. 8, 2005

(30) Foreign Application Priority Data
Sep. 11, 2002 (EP) 02292222.3

(51) Int. Cl. H04N 7/12

(52) U.S. Cl. 375/240.16; 375/240.12

(57) ABSTRACT

The invention relates to a video coding method for the compression of a coded bitstream corresponding to an original video sequence that has been divided into successive groups of frames (GOFs). This method, applied to each GOF of the sequence, comprises: (a) a spatio-temporal analysis step, leading to a spatio-temporal multiresolution decomposition of the current GOF into low and high frequency temporal subbands and itself comprising a motion estimation sub-step, a motion compensated temporal filtering sub-step and a spatial analysis sub-step, and; (b) an encoding step, performed on said low and high frequency temporal subbands and on motion vectors obtained by means of said motion estimation step. According to the invention, said spatio-temporal analysis step also comprises a decision sub-step for dynamically choosing the input GOF size, said decision sub-step itself comprising a motion activity pre-analysis operation based on the MPEG-7 Motion Activity descriptors and performed on the input frames of the first temporal decomposition level to be motion compensated and temporally filtered.

### FIELD OF THE INVENTION

The present invention relates to a video coding method for the compression of a bitstream corresponding to an original video sequence that has been divided into successive groups of frames (GOFs) the size of which is N=2ⁿ with n=0, or 1, or 2, . . . , said coding method comprising the following steps, applied to each successive GOF of the sequence:

a) a spatio-temporal analysis step, leading to a spatio-temporal multiresolution decomposition of the current GOF into 2ⁿ low and high frequency temporal subbands, said step itself comprising the following sub-steps:
a motion estimation sub-step;
based on said motion estimation, a motion compensated temporal filtering sub-step, performed on each of the 2ⁿ⁻¹ couples of frames of the current GOF;
a spatial analysis sub-step, performed on the subbands resulting from said temporal filtering sub-step;

b) an encoding step, performed on said low and high frequency temporal subbands resulting from the spatio-temporal analysis step and on motion vectors obtained by means of said motion estimation step.

The invention also relates to a video coding device for carrying out said coding method.

### BACKGROUND OF THE INVENTION

Video streaming over heterogeneous networks requires a high scalability capability. That means that parts of a bitstream can be decoded without a complete decoding of the sequence and combined to reconstruct the initial video information at lower spatial or temporal resolutions (spatial/temporal scalability) or with a lower quality (PSNR or bitrate scalability). A convenient way to achieve all these three types of scalability (scalable, temporal, PSNR) is a three-dimensional (3D, or 2D+t) subband decomposition of the input video sequence, performed after a motion compensation of said sequence.

Current standards like MPEG-4 have implemented limited scalability in a predictive DCT-based framework through additional high-cost layers. More efficient solutions based on a 3D subband decomposition followed by a hierarchical encoding of the spatio-temporal trees-performed by means of an encoding module based on the technique named Fully Scalable Zerotree (FSZ)-have been recently proposed as an extension of still image coding techniques for video: the 3D or (2D+t) subband decomposition provides a natural spatial resolution and frame rate scalability, while the in-depth scanning of the coefficients in the hierarchical trees and the progressive bitplane encoding technique lead to the desired quality scalability. A higher flexibility is then obtained at a reasonable cost in terms of coding efficiency.

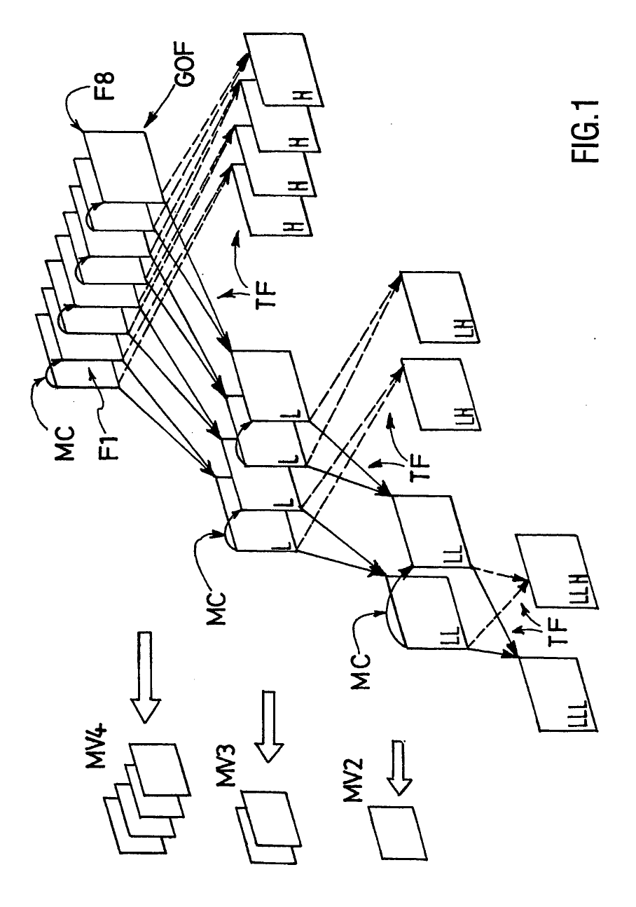

The ISO/IEC MPEG normalization committee launched at the 58^{th} Meeting in Pattaya, Thailand, Dec. 7, 2001, a dedicate AdHoc Group (AHG on Exploration of Interframe Wavelet Technology in Video Coding) in order to, among other things, explore technical approaches for interframe (e.g. motion-compensated) wavelet coding and analyze in terms of maturity, efficiency and potential for future optimization. The codec described in the document PCT/EP01/04361 (PHFR000044) is based on such an approach, illustrated in FIG. 1 that shows a temporal subband decomposition with motion compensation. In that codec, the 3D wavelet decomposition with motion compensation is applied to a group of frames (GOF), these frames being referenced F1 to F8 and organized in successive couples of frames. Each GOF is motion-compensated (MC) and temporally filtered (TF), thanks to a Motion Compensated Temporal Filtering (MCTF) module. At each temporal decomposition level, resulting low frequency temporal subbands are, similarly, further filtered, and the process stops when there is only one temporal low frequency subband left (in FIG. 1, where three stages of decomposition are shown: L and H=first stage; LL and LH=second stage; LLL and LLH=third stage, it is the root temporal subband called LLL), which represents a temporal approximation of the input GOF. Also at each decomposition level, a group of motion vector fields is generated (in FIG. 1, MV4 at the first level, MV3 at the second one, MV2 at the third one). After these two operations have been performed in the MCTF module, the frames of the temporal subbands thus obtained are further spatially decomposed and yield a spatio-temporal tree of subband coefficients.

With Haar filters used for the temporal filtering operations, motion estimation (ME) and motion compensation (MC) are only performed every two frames of the input sequence, the total number of ME/MC operations required for the whole temporal tree being roughly the same as in a predictive scheme. Using these very simple filters, the low frequency temporal subband represents a temporal average of the input couple of frames, whereas the high frequency one contains the residual error after the MCTF operation.

It may then be observed that the whole efficiency of any MC 3D subband video coding scheme depends on the specific efficiency of its MCTF module in compacting the temporal energy of the input GOF. Said efficiency itself depends on the motion information and the way in which such information is processed. For instance, in low motion activity video sequences, a strong temporal correlation exists between the input frames, which is no longer verified in high motion activity sequences.

### SUMMARY OF THE INVENTION

It is therefore an object of the invention to propose an encoding method with which an improved coding efficiency is obtained by taking into account the above-mentioned observation related to the motion activity.

To this end, the invention relates to a coding method such as defined in the introductory paragraph of the description and which is moreover characterized in that said spatio-temporal analysis step also comprises a decision sub-step for dynamically choosing the input GOF size, said decision sub-step itself comprising a motion activity pre-analysis operation based on the MPEG-7 Motion Activity descriptors and performed on the input original frames of the first temporal decomposition level to be motion compensated and temporally filtered.

According to a particularly advantageous implementation, said method is characterized in that said decision sub-step, based on the Intensity of activity attribute of the MPEG-7 Motion Activity Descriptors for all the frames or subbands of the current temporal decomposition level, comprises, for the first temporal decomposition level having a GOF size equal to N input original frames, the following operations:

a) perform ME between each couple of frames that compose said first level:
for each couple:
   compute the standard deviation of motion vector magnitude;
   compute the Activity value.

b) compute the average activity Intensity I(av):
if I(av) is strictly above a specified value, for instance corresponding to a medium intensity, it is decided to reduce the input GOF size by half N and do again the analysis on the new GOF thus obtained;
if I(av) is equal to said specified value, it is decided to keep the current GOF size value and perform MCTF on this GOF;
if I(av) is strictly below said specified value, it is decided to increase the input GOF size by doubling N and do again the analysis on the new GOF thus obtained.

Since the GOF size selection for the first temporal decomposition level (composed of input original frames) is partly based on the ME of these frames, this technical solution leads to a low complexity increase of the overall MCTF module, that will however eventually re-use this very same motion information for its own process. Moreover, it must be noted that changing from one GOF size to another one does not require a complete re-analysis of the input original frames since many motion information are already available.

It is another object of the invention to propose a coding device for carrying out such a coding method.

To this end, the invention relates to a video coding device for the compression of a bitstream corresponding to an original video sequence that has been divided into successive groups of frames (GOFs) the size of which is N=2ₙ with n=0, or 1, or 2, . . . , said coding device comprising the following elements:

a) spatio-temporal analysis means, applied to each successive GOF of the sequence and leading to a spatio-temporal multiresolution decomposition of the current GOF into 2ₙ low and high frequency temporal subbands, said analysis means themselves comprising:
a motion estimation circuit;
based on the result of said motion estimation, a motion compensated temporal filtering circuit, applied to each of the 2ⁿ⁻¹ couples of frames of the current GOF;
a spatial analysis circuit, applied to the subbands delivered by said temporal filtering circuit;

b) encoding means, applied to the low and high frequency temporal subbands delivered by said spatio-temporal analysis means and to motion vectors delivered by said motion estimation circuit, said encoding means delivering an embedded coded bitstream;

said coding device being further characterized in that said spatio-temporal analysis means also comprise a decision circuit for choosing the input GOF Size, said decision circuit itself comprising a motion activity pre-analysis stage, using the MPEG-7 Motion Activity descriptors and applied to the input frames of the first temporal decomposition level to be motion compensated and temporally filtered.

### BRIEF DESCRIPTION OF THE DRAWINGS

The present invention will now be described with reference to the accompanying drawings in which FIG. 1 illustrates a temporal subband decomposition of an input video sequence, with motion compensation.

### DETAILED DESCRIPTION OF THE INVENTION

As said above, the whole efficiency of any MC 3D subband video coding scheme depends on the specific efficiency of its MCTF module in compacting the temporal energy of the input GOF. As the parameter “GOF size” is a major one for the success of MCTF, it is proposed, according to the invention, to derive this parameter from a dynamical Motion Activity pre-analysis of the input original frames (the ones that compose the first temporal level) to be motion-compensated and temporally filtered, using normative (MPEG-7) motion descriptors (see the document “Overview of the MPEG-7 Standard, version 6.0”, ISO/IEC JTC1/SC29/WG11 N4509, Pattaya, Thailand, December 2001, pp.1-93). The following description will define which descriptor is used and how it influences the choice of the above-mentioned encoding parameter.

In the 3D video coding scheme described above, ME/MC is generally arbitrarily performed on each couple of frames (or subbands) of the current temporal decomposition level. It is now proposed, according to the invention, to dynamically choose the input GOF size according to the “intensity of activity” attribute of the MPEG-7 Motion Activity Descriptors, and this for all the frames of the first temporal decomposition level. In the present example of implementation, “intensity of activity” takes its integer values within the [1, 5] range: for instance 1 means a “very low intensity” and 5 means “very high intensity”. This Activity Intensity attribute is obtained by performing ME as it would be done anyway in a conventional MCTF scheme and using statistical properties of the motion-vector magnitude thus obtained. Quantized standard deviation of motion-vector magnitude is a good metric for the motion Activity Intensity, and Intensity value can be derived from the standard deviation using thresholds. The input GOF size will therefore be obtained as now described:

“for the first temporal decomposition level having a GOF Size equal to N input original frames, the following operations are performed:

a) perform ME between each couple of frames that composes said first level:
for each couple:
   compute the standard deviation of motion vector magnitude;
   compute the Activity value.

b) compute the average Activity Intensity I(av):
if I(av) is strictly above a user-specified value (for instance corresponding to a medium intensity), it is decided to reduce the input GOF size by half N and do again the analysis on the new GOF thus obtained;
if I(av) is equal to said specified value, it is decided to keep the current GOF size value and perform MCTF on this GOF;
if I(av) is strictly below said specified value, it is decided to increase the input GOF size by doubling N and do again the analysis on the new GOF thus obtained”.

If the GOF size is doubled, that means that the first half of the new GOF will be composed of the already loaded frames and the other half of the following frames, and the analysis (ME and I(av) computation) will be made only on the newly loaded frames. Otherwise, if GOF size is halved, all the required information needed for the new analysis has been already computed and only I(av) must be recomputed for the half-GOF. Therefore, the present invention represents a small overall complexity increase in comparison with a conventional process in which GOF size is arbitrarily chosen and fixed for the whole sequence.

1. A video coding method for the compression of a bitstream corresponding to an original video sequence that has been divided into successive groups of frames (GOFs) the size of which is N=2ⁿ with n=0, or 1, or 2, . . . , said coding method comprising the following steps, applied to each successive GOF of the sequence:
a) a spatio-temporal analysis step, leading to a spatio-temporal multiresolution decomposition of the current GOF into 2ⁿ low and high frequency temporal subbands, said step itself comprising the following sub-steps:
a motion estimation sub-step;
based on said motion estimation, a motion compensated temporal filtering sub-step, performed on each of the 2ⁿ⁻¹ couples of frames of the current GOF;
a spatial analysis sub-step, performed on the subbands resulting from said filtering sub-step;
b) an encoding step, performed on said low and high frequency temporal subbands resulting from the spatio-temporal analysis step and on motion vectors obtained by means of said motion estimation step;
said coding method being further characterized in that said spatio-temporal analysis step also comprises a decision sub-step for dynamically choosing the input GOF size, said decision sub-step itself comprising a motion activity pre-analysis operation based on the MPEG-7 Motion Activity descriptors and performed on the input original frames of the first temporal decomposition level to be motion compensated and temporally filtered.

2. A coding method according to claim 1, said decision sub-step being based on the Intensity of activity attribute of the MPEG-7 Motion Activity Descriptors for all the frames of the first temporal decomposition level and comprising, for said first temporal decomposition level having a GOF size equal to N input original frames, the following operations:
a) perform ME between each couple of frames that compose said first level:
for each couple:
compute the standard deviation of motion vector magnitude;
compute the Activity value.
b) compute the average Activity Intensity I(av):
if I(av) is strictly above a user-specified value (for instance corresponding to a medium intensity), it is decided to reduce the input GOF size by half N and do again the analysis on the new GOF thus obtained;
if I(av) is equal to said specified value, it is decided to keep the current GOF size value and perform MCTF on this GOF;
if I(av) is strictly below said specified value, it is decided to increase the input GOF size by doubling N and do again the analysis on the new GOF thus obtained.

3. A video coding device for the compression of a bitstream corresponding to an original video sequence that has been divided into successive groups of frames (GOFs) the size of which is N=2ⁿ with n=0, or 1, or 2, . . . . , said coding device comprising the following elements:
a) spatio-temporal analysis means, applied to each successive GOF of the sequence and leading to a spatio-temporal multiresolution decomposition of the current GOF into 2ₙ low and high frequency temporal subbands, said analysis means themselves comprising:
a motion estimation circuit;
based on the result of said motion estimation, a motion compensated temporal filtering circuit, applied to each of the 2ⁿ⁻¹ couples of frames of the current GOF;
a spatial analysis circuit, applied to the subbands delivered by said temporal filtering circuit;
b) encoding means, applied to the low and high frequency temporal subbands delivered by said spatio-temporal analysis means and to motion vectors delivered by said motion estimation circuit, said encoding means delivering an embedded coded bitstream;
said coding device being further characterized in that said spatio-temporal analysis means also comprise a decision circuit for choosing the input GOF Size, said decision circuit itself comprising a motion activity pre-analysis stage, using the MPEG-7 Motion Activity descriptors and applied to the input frames of the first temporal decomposition level to be motion compensated and temporally filtered.
